(19) United States
(12) Patent Application Publication
(10) Pub. No.: US 2007/0147609 A1
(43) Pub. Date: Jun. 28, 2007

(54) Information processing method and information processing apparatus

(76) Inventors: Takaharu Noguchi, Yokohama (JP); Akira Shibata, Fujisawa (JP); Shigeru Komatsu, Yokohama (JP); Atsushi Ogawa, Tokyo (JP); Goro Umeda, Matsudo (JP)

Correspondence Address: MCDERMOTT WILL & EMERY LLP, 600 13TH STREET, N.W., WASHINGTON, DC, 20005-3096, US

(21) Appl. No.: 11/517,554

(22) Filed: Sep. 8, 2006

(30) Foreign Application Priority Data
Dec. 26, 2005 (JP) 2005-371299

(51) Int. Cl. H04N 7/167

(52) U.S. Cl. 380/201

(57) ABSTRACT

An apparatus and a method for processing video and audio information therein, comprising: an encrypting circuit for coping with a copyright management system, which adopts an encrypting method differing from each other depending on a region where it is used; and an input portion, through which information of the region of use is inputted, wherein an encrypting method of said encrypting circuit is selected, upon basis of said information of the region of use, which is obtained from said input portion, through which information of the region of use is inputted, thereby processing the video and audio information.

### BACKGROUND OF THE INVENTION

The present invention relates to an information processing method and an information processing apparatus.

As a background technology within the technical field relating to the present invention, there is already known the following Non-Patent Document 1, for example. In this document, these following technologies are described. These are as follows; “(1) Content scramble: Copyrighted material (MPEG compressed content) is scrambled using three layered encryption keys. Only DVD produces with licensed technology can obtain and playback the copyrighted material. (2) Bus authentication: DVD ROM drive and MPEG decoder module mutually authenticate through PC bus. The descrambling key is further encrypted by a time variable key. This mechanism prevents unauthorized copy of copyrighted material on PC bus and its playback.” And also as other background technologies, there are already known the following Non-patent Document 2 to 4.

[Non-Patent Document 1] National Technical Report Vol. 43 No.3 June. 1997 (pp 339-341);

[Non-Patent Document 2] Digital Transmission Content Protection Specification Volume 1 (Informational Version) Revision 1.3, January, 2004 published from Digital Transmission Licensing Administrator, LLC (http://www.dtcp.com);

[Non-Patent Document 3] DTCP Volume 1 Supplement E Mapping DTCP to IP (Informational Version) Revision 1.0, Nov. 24, 2003 published from Digital Transmission Licensing Administrator, LLC (http://www.dtcp.com); and

[Non-Patent Document 4] High-Definition Multimedia Interface Specification Version 1.1, May 20, 2004 published from HDMI Licensing, LLC. (http://www.hdmi.org) High-bandwidth Digital Content Protection System Revision 1.1, Jun. 9, 2003 published from Digital Content Protection LLC. (http://www.digital-cp.com).

### BRIEF SUMMARY OF THE INVENTION

The present invention relates to a method and an apparatus for enabling management of the copyrights of AV information, i.e., including video (pictures) and audio (sounds) therein, such as, movies, representatively, for example, in accordance with a way of thinking of the copyrights, which differs in each of areas or regions, such as, countries, etc., so that the AV information can be enjoyed in every countries of the world crossing the borders.

For DVD appearing in 1996, standing on the difference between a request from the movie companies and a custom in each of the countries relating to the movies, there is adopted a copyright management method, being so-called “Regional Coding (hereinafter, “RC”)”, is adopted, however thereafter, due to changes on the markets and/or changes in strategies of the movie companies for supplying the movies, the present RC comes to be a device or mechanism having a lot of problems therein. Also, regarding an encryption technology, i.e., a main technology for management of the copyrights, there is a case where “the country approve or authorize the encryption method” by an order of an institute of the state, No. 273 (1999, Oct. 7), like the People's Republic of China, for example, and there appears necessity of changing the encryption method for each of the regions. The followings are already known as the encryption methods relating to management of the copyrights; i.e., DVD-CSS, DVD-CPRM, DTCP, DTCP-IP, HDMI&HDCP, Display Port, UDI, etc., and all of those encryption methods or a portion thereof must be changed for each of the regions. However, relating to the methods, DVD-CSS, DTCP, DTCP-IP and HDMI&HDCP, please refer to the Non-Patent Documents mentioned above.

In case when a specific country adopts an encrypting method differing from that of the standard in Japan and USA, it is impossible to reproduce the AV information, in a relationship between a medium recording the AV information adopting the different encryption method and a reproducing apparatus. In the similar manner, it is also impossible to transmit the AV information, in a relationship between an output apparatus of the AV information adopting the different encryption method and an input apparatus. Further, it is also impossible to reproduce the AV information, in a relationship between a recording medium having the different RC and a reproducing apparatus for a recording medium.

According to the present invention, an object thereof is to provide a method and an apparatus enabling connection between equipments, each having different encryption method, and also a method and an apparatus for a new RC, for achieving equipments enabling to reproduce the recording media, each having different RC and encryption. Thus, it is the object to provide a method for enabling to produce permitted AV information by means of permitted equipments, under a use condition that a copyright owner allows, irrespective of the regions or areas where sales thereof are made, and also a reproducing apparatus thereof.

In brief, the object thereof is to achieve an improvement on usability of an information processing apparatus.

Such the object mentioned above can be accomplished by the invention as described in the pending claims, which will be mentioned below.

### BRIEF DESCRIPTION OF THE SEVERAL VIEWS OF THE DRAWING

Those and other objects, features and advantages of the present invention will become more readily apparent from the following detailed description when taken in conjunction with the accompanying drawings wherein:

FIG. 1 is a block diagram for showing an embodiment, in which a media reproducing apparatus according to the present invention is connected with a television apparatus according to the present invention;

FIG. 2 is a block diagram for showing an decryption circuit 105 to be applied into the present invention;

FIG. 3 is a block diagram for showing an encrypting circuit 106 to be applied into the present invention; and

FIG. 4 is a block diagram for showing an encrypting circuit 110 to be applied into the present invention.

### DETAILED DESCRIPTION OF THE INVENTION

Hereinafter, embodiments according to the present invention will be fully explained by referring to the attached drawings.

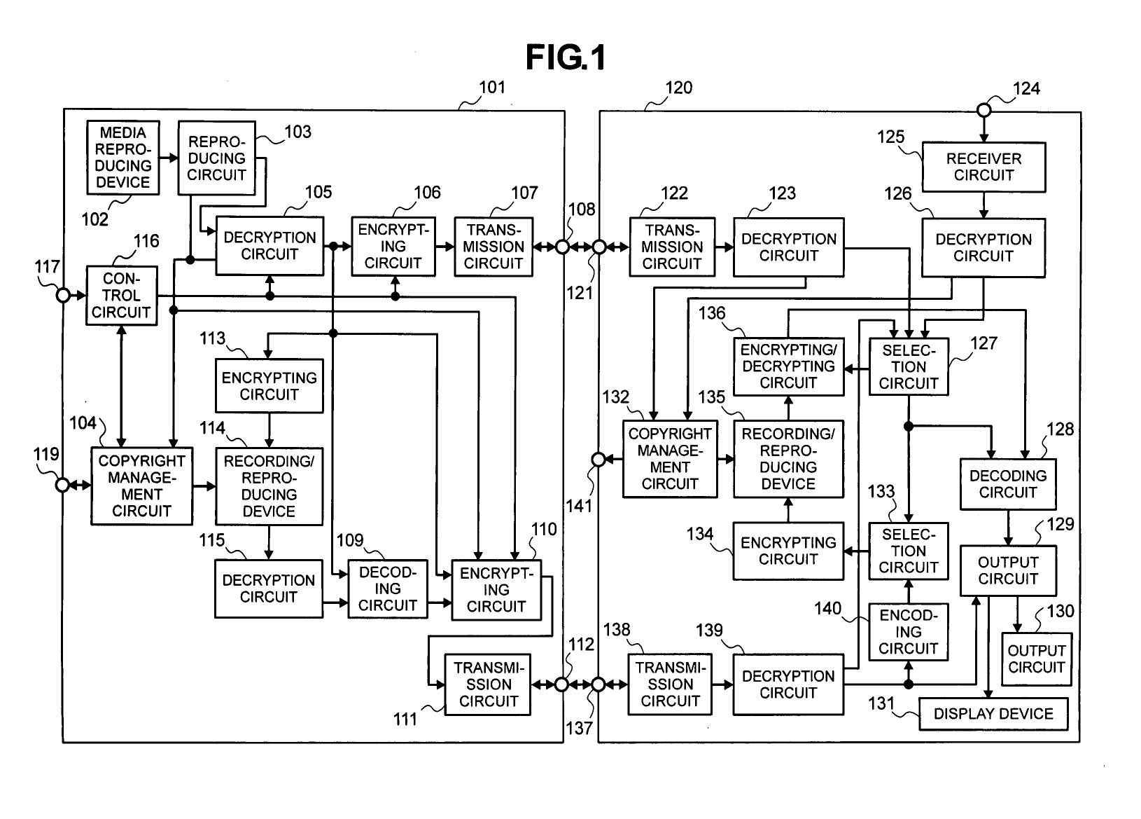

FIG. 1 shows a reproducing apparatus 101 for reproducing media, onto which AV information is recorded, such as, DVD, Blu-ray, HD DVD, etc., for example, and a television (receiver) apparatus 120 for displaying thereon the AV information, which is reproduced by that reproducing apparatus, according to the present embodiment.

A reference numeral 102 depicts a media reproducing apparatus or device, for DVD, Blu-ray, HD DVD, and this outputs signal group data, including an encoded signal, an RC signal, and a copy management signal: Copy Generation Management signal (hereinafter, “CGM” signal) therein. The said signal group data are demodulated within a reproduction circuit 103, and are treated with error correction thereon. The RC signal and the CGM signal are inputted into a copyright management circuit 104, and the compressed and demodulated signal is inputted into a decryption circuit 105.

The decryption circuit 105 decrypts both a key-length code of 40 bits for DVD and a key-length code of 128 bits being common with Blu-ray and HD DVD. The decryption circuit 105 supplies the AV information, which is compressed in data thereof, to an encrypting circuit 106 for an external terminal 108, a decoding circuit 109 for expanding or decompressing the compressed AV information, and an encrypting circuit 110 for a second external terminal 112.

An output signal of the decryption circuit 105 and the RC signal and the CGM signal from the reproduction circuit 103, in addition to an output signal of the decoding circuit 109 are inputted to the an encrypting circuit 110. Within the encrypting circuit 110, those three (3) input signals, after being time-division multiplexed, are encrypted with a key length of 40 bits or 56 bits, or with a key-length of 128 bits, and are outputted from external terminal 112 through a transmission circuit 111.

In case when the media reproducing device 102 tries to reproduce pre-recorded media in accordance with the Chinese standard, “information indication on whether an encryption will be treated or not upon the signal outputted from the external terminal 112” is included within the CGM signal, which is outputted from the reproduction circuit 103, and if this information indicates the encrypting, encryption with the key-length of 128 bits is conducted, on the other hand, if the information does not indicate the encrypting, the time-division multiplexed signal without conducting the encryption thereon is transmitted to the transmission circuit 111.

In case when the media reproducing device 102 tries to reproduce the existing DVD media and/or the Blue-ray media, the time-division multiplexed signal is always encrypted in the encrypting circuit 110.

The compressed AV information, i.e., the output of the decryption circuit 105 is inputted into an encrypting circuit 113 for encryption fixed with an encrypting method thereof, having a predetermined capability of security, having the key-length of 56 bits or 128 bits, for example, and after being encrypted, it is recorded into a built-in recording/reproducing device 114, such as, a HDD, a nonvolatile semiconductor memory, etc., for example. In case when the recording/reproducing device 114 is in a reproduction mode, after being decrypted within a code decrypting circuit 115, the output signal of the recording/reproducing device 114 is inputted into the decoding circuit 109. In the decoding circuit 109, this input signal is decoded prior to the signal(s) from the decryption circuit 105.

The reproducing apparatus 101 has a device or mechanism for enabling to deal with the copyright management system, which adopts an different encrypting method, depending on the regions or areas where it is used. Within the reproducing apparatus 101, a terminal 117 for inputting a regional information of use is provided, and the regional information of use, which is inputted from the terminal 117, is inputted into a control circuit 116. The control circuit 116 controls the copyright management circuit 104, the encryption/decryption circuit 105, the encrypting circuits 106 and 110, which are provided for dealing with the copyright management systems differing from one another depending upon the regions of use thereof.

For example, when the destination thereof includes Japan, USA, or Europe, and if the external terminal 108 is in accordance with the DTCP-IP standard when shipping the products, then the encryption method of the encrypting circuit 106 is set into an AES method of 128 bits, if the external terminal 112 is in accordance with the HDMI standard, the encrypting method of the encrypting circuit 110 is set into the HDCP having the key-length of 40 bits or 56 bits, if the media reproducing device 102 is in accordance with the DVD, Blu-ray or HD DVD, the decrypting method of the code decryption circuit 105 is set into a CSS method having key-length of 40 bits when reproducing the DVD, or an AACS method having key-length of 128 bits when reproducing the Blu-ray or the HD DVD, respectively. The output signal of the encrypting circuit 106 reaches to the external terminal 108 through a transmission circuit 107. An output signal of the encrypting circuit 110 reaches to the external terminal 112 through the transmission circuit 111.

However, since the encrypting circuit 113 and the decryption circuit 115 are designed for exclusive use of the recording/reproducing device 114, it is possible to select a specific encrypting method, irrespective of the regions or areas where the reproducing apparatus 101 is used. Within the copyright management circuit 104, the RC is set up corresponding to the destination at shipping the products.

The reproducing apparatus 101 has an Internet connector terminal 119, where copyright control information from a site of copyright management is transmitted to the copyright management circuit 104 through the Internet. The RC signal and the CGM signal from the reproduction circuit 103 are also inputted to the copyright management circuit 104.

At recording of the output signal from the decryption circuit 105 into the recording/reproducing device 114, the CGM signal outputted from the reproduction circuit 103 is inputted into the copyright management circuit 104, and in case when that CGM signal allows “Copy Free”, “Copy Once”, “Move” or recording with limited reproducing period, the copyright management circuit 104 controls the recording/reproducing device 114 to record the signal according to the said recording condition. Even in case where that CGM signal inhibits copying, such as, “Copy Never” or the like, for example, the copyright management circuit controls the recording/reproducing device 114 to record the signal, if a copy permission from a copyright manager through the Internet can be obtained.

Thus, when a user tries to record the AV information inhibiting copying thereof, the copyright management circuit 104 transmits license-obtaining information obtained from the said copyright manager, which is owned by the reproducing apparatus 101, automatically, to the copyright manager site through the Internet, in accordance with the information included within the CGM signal, corresponding to that AV information, and it also applies a copy permission thereto. Said the copyright manager site certifies the reproducing apparatus 101 to be a license-obtaining product, and it gives a right of ordinary recording, or recording with limited reproducing period, to the recording/reproducing device 114, which is built within that reproducing apparatus 101. When the recording permission is issued from the copyright manager site through the Internet, the recording/reproducing device 114 starts the recording in accordance with this.

The television (receiver) apparatus 120 has a digital broadcast-capable television function, comprising an antenna terminal 124, a receiver circuit 125, a decryption circuit 126, a decoding circuit 128 for expanding the AV signal compressed, to turn it back to an original AV signal, an output circuit 129 for the AV signal, an output circuit (a speaker) 130 and a display device 131.

The television apparatus 120 has an external terminal 121, in accordance with the DTCP-IP standard, wherein the compressed AV signal and the CGM signal inputted at the external terminal 121 are inputted into a selection circuit 127 through a transmission circuit 122 and an encryption/decryption circuit 123.

The television apparatus 120 also has an external terminal 137, in accordance with the HDMI standard, wherein the compressed AV signal, non-compressed AV signal and the CGM signal inputted at the external terminal 137 are inputted passing through a transmission circuit 138 and a decryption circuit 139 of HDMI; i.e., the non-compresses AV signal is inputted into the AV signal output circuit 129, the compressed AV signal is inputted into the selection circuit 127, and the CGM signal is inputted into a copyright management circuit 132.

One of the compressed AV signals, which is selected within the selection circuit 127, is inputted into the decoding circuit 128, and also inputted into a selection circuit 133. And also an output signal of an encoding circuit 140 is inputted into the selection circuit 133, for compressing the non-compressed AV signal within the output signals of a decryption circuit 139.

The television apparatus 120 also has a recording/reproducing function therein, which is constructed with an encrypting circuit 134, a recording/reproducing device 135, such as, HDD or the like, and a decrypting circuit 136. An output of the selection circuit 133 is encrypted within the encrypting circuit 134, and recorded into the recording/reproducing device 135. Under a reproducing mode of the recording/reproducing device 135, an output signal of the recording/reproducing device 135 is decrypted within the decrypting circuit 136, and the output signal is inputted into the decoding circuit 128, and it reaches to the speaker 130 and the display apparatus 131 through the output circuit 129.

The television apparatus 120 has an Internet connector terminal 141, wherein the copyright control information from the copyright manager is sent to the copyright management circuit 132 through the Internet. The CGM signals from the decryption circuits 123, 126 and 139 are also inputted respectively into the copyright management circuit 132.

In case when recording the output signals of the decryption circuits 123, 126 and 139 into the recording/reproducing device 135, respectively, the CGM signal outputted from the decryption circuits 123, 126 or 139 is inputted into the copyright management circuit 132, and in case where said the CGM signal allows “Copy Free”, “Copy Once”, “Move” or recording with limited reproducing period, the copyright management circuit 132 controls the recording/reproducing device 135 in accordance with that recording condition. Even in case when that CGM signal prohibits the copying, such as, “Copy Never” or the like, for example, the copyright management circuit controls the recording/reproducing device 135, if it can obtain a copy permission from a copyright manager through the Internet can be obtained.

Thus, when a user tries to record the AV information inhibiting copying thereof, the copyright management circuit 132 transmits license-obtaining information obtained from the said copyright manager, which is owned by the television apparatus 120, automatically, to the copyright manager site through the Internet, in accordance with the information included within the CGM signal, corresponding to that AV information, and it also applies a copy permission thereto. Said the copyright manager site certifies the television apparatus 120 to be a license-obtaining product, and it gives a right of ordinary recording, or recording with limited reproducing period, to the recording/reproducing device 135, which is built within that television apparatus 120. When the recording permission is issued from the copyright manager site through the Internet, the recording/reproducing device 135 starts the recording in accordance with this.

Next, explanation will be made on the case where the television apparatus 120, which is a product to be exported to China, and the reproducing apparatus 101, which is a product to be shipped towards Japan, USA and Europe, are connected as is shown in FIG. 1, within China. The television apparatus 120 selects the output signal at the DTCP-IP external terminal of the reproducing apparatus 101, communication is conducted between the transmission circuit 107 of the reproducing apparatus 101 and the transmission circuit 122 of the television apparatus 120. Since the transmission circuit 122 transmits a fact that the encryption method, which the television apparatus 120 installed therein, is the Chinese standard (i.e., key-length of 128 bits) to the transmission circuit 107, then the transmission circuit 107 determines that the television apparatus adopt the DTCP-IP encryption method, being the Chinese standard, and it change the encryption method within the encrypting circuit 106 into the encryption method of the Chinese standard. Thus, the television apparatus encrypts the AV information with that Chinese method, and it is sent from the external terminal 108 to the external terminal 121 of the television apparatus 120.

In the similar manner, in case where the television apparatus 120 selects the output signal to get at the HDMI external terminal 112, communication is conducted between the transmission circuit 111 of the reproducing apparatus 101 and the transmission circuit 138 of the television apparatus 120. With this communication, the transmission circuit 111 determines that the television apparatus adopts the HDMI encryption method (having the key-length of 128 bits) of the Chinese standard, to switch over the encryption method of the encrypting circuit 110 from the key-length of 40 bits or 56 bits of the standard of Japan, USA and Europe into the encryption method having key-length of 128 bits of the Chinese standard; i.e., the AV information requested from the television apparatus 120 is encrypted in accordance with that Chinese method, and it is sent out from the external terminal 112 to the external terminal 137 of the television apparatus 120.

Next, explanation will be made on the case where the reproducing apparatus 101 which is shipped to USA reproduce the pre-recorded media, which are sold in China and USA, within China. The pre-recorded media, which are domestically sold within China, adopts the encryption methods of the Chinese standard and the RC corresponding to China, while the pre-recorded media, which are sold within USA, adopts the encryption methods of the US standard and the RC corresponding to USA. When trying to reproduce the pre-recorded media, which are sold within China by means of the media reproducing device 102, the RC signal or the CGM signal is read out from the reproducing circuit 103, and this signal is analyzed within the copyright management circuit 104, and it is determined that the RC is the Chinese region and the encryption method is the Chinese method. Since the RC in the media and the apparatus differs from each other, then the reproducing apparatus displays “Reproduction cannot be made because RC is different”, etc., and then the user issues an instruction from the input terminal 117 through the to the control circuit 116 to the copyright management circuit 104, with using a operating means, such as, a remote controller, etc., thereby switching over the RC of the reproducing apparatus 101 from USA into the Chinese region, as well as, changing the method of the decryption circuit 105 from the standard of Japan, USA and Europe into the Chinese standard.

Information for certification of obtaining the license relating to the copyright, such as, an ID number or the like is embedded within the control circuit 116 and the copyright management circuit 104, and as was mentioned above, in case when using the product, which is shipped towards USA, within China, the external terminal 119 may be connected to the said copyright management site through the Internet, so that the said site exchanges the RC and the encryption method or allows the RC of both USA and China, when making an application for changing the information for certification of obtaining the license and the RC from USA to China region, in the mechanism thereof. After being allowed the RC of both countries, USA and China, from the copyright management site, the copyright management circuit 104 can automatically switch the RC of the reproducing apparatus 101, in accordance with the RC reproduced from the pre-recorded media.

Exchange of the encryption method within the encrypting circuits 106 and 110 of the reproducing apparatus 101 can be also done, similar to that of the RC, from the method of Japan, USA and Europe to the Chinese method, in accordance with the user's operation on the remote controller or the like, and/or a result of determination within the copyright management circuit 104, while interlocking or coupling a default of the encryption method in the encrypting circuits 106 and 110 with the RC of the decryption circuit 105.

Next, explanation will be made on the case where the encrypting circuit 110 within the reproducing apparatus 101 has not the encryption method of the Chinese standard, and the television apparatus 120 selects the output signal of the external terminal according to the HDMI standard. As was mentioned above, mutual communication is conducted between the HDMI transmission circuits 111 and 138, and the transmission circuit 138 and the decryption circuit 139 recognize and determine that the HDMI method of the output signal from the external terminal 112 is based on the method of Japan, USA and Europe, so that the encryption method of the decryption circuit 139 selects the method having key-length of 40 bits or 56 bits, so as to decrypt it.

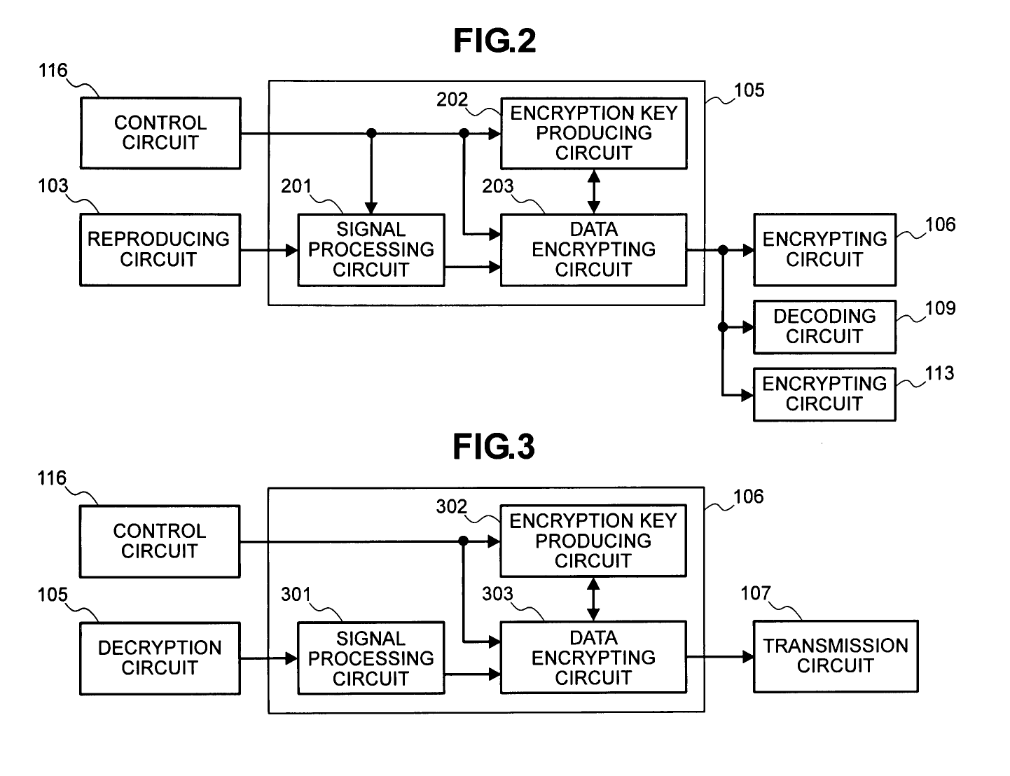

FIG. 2 shows the decryption circuit 105 to be applied into the present embodiment. The encrypted AV signal from the reproducing circuit 103 is inputted into a signal processing circuit, and also from the control circuit 116, a signal indicated whether the encryption method of the encrypted AV signal is the CSS having key-length of 40 bits, or the AACS having key-length of 128 bits, is inputted into an encryption key producing circuit 202, the signal processing circuit 201 and a data encrypting circuit 203.

In case where the input signal from the control circuit 116 indicates the key-length of 40 bits, the signal processing circuit 201 supplies the signal by a unit of 40 bits, to the data encrypting circuit 203. Also, the encryption key producing circuit 202 supplies a data encryption key signal having key length of 40 bits to the data encrypting circuit 203, and the data encrypting circuit 203 supplies the decrypted AV signal to the encrypting circuit 106, the decoding circuit 109 and the encrypting circuit 113.

In case where the input signal from the control circuit 116 indicates the key-length of 128 bits, the signal processing circuit 201 supplies the signal by a unit of 128 bits, to the data encrypting circuit 203. Also, the encryption key producing circuit 202 supplies a data encryption key signal having key length of 128 bits to the data encrypting circuit 203, and the data encrypting circuit 203 supplies the decrypted AV signal to the encrypting circuit 106, the decoding circuit 109 and the encrypting circuit 113.

FIG. 3 shows the encrypting circuit to be applied into the present embodiment. The decrypted AV signal is inputted from the decryption circuit 105 into a signal processing circuit 301, and at the same time, from the control circuit 116, the signal indicated which area or region is the operation region or area of the reproducing apparatus is inputted into an encryption key producing circuit 302 and a data encrypting circuit 303.

Since the key length of the encrypting circuit 106 is fixed at 128 bits and the encrypting circuit 106 has a plural number of encryption methods, then the signal processing circuit 301 always supplies the signal by a unit of 128 bits to the data encrypting circuit 303.

In case where the input signal from the control circuit 116 indicate Japan, USA and Europe region, the encryption key producing circuit 302 and the data encrypting circuit 303 execute the encryption with the key length of 128 bits, in accordance with the DTCP-IP standard, and supply the data encryption key signal of 128 bits to the data encrypting circuit 303, and the data encrypting circuit 303 supplies the re-encrypted AV signal re-encrypted to the transmission circuit 107.

In case where the input signal from the control circuit 116 indicates the China region, then the encryption key producing circuit 302 and the data encrypting circuit 303 execute the encryption with the key length of 128 bits, in accordance with the Chinese encryption standard, then supply a data encryption key signal of 128 bits to the data encrypting circuit 303, and the data encrypting circuit 303 supplies the re-decrypted AV signal to the transmission circuit 107.

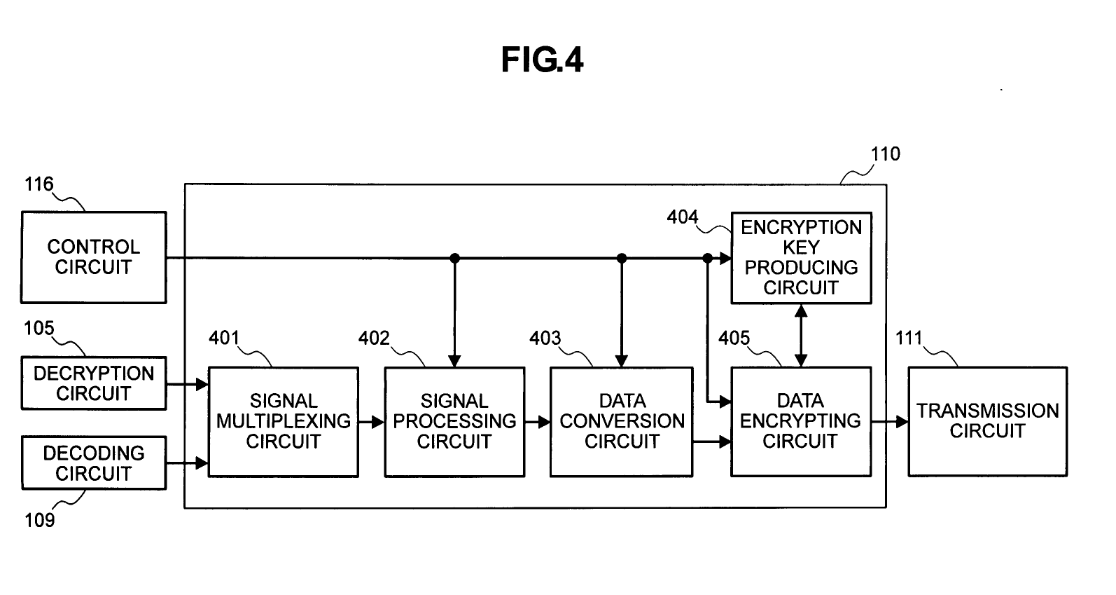

FIG. 4 shows the embodiment of the encrypting circuit 110 to be applied into the present invention. The decoded AV signal from the decoding circuit 109 and the compressed AV signal, the RC and the CGM signal from the decryption circuit 105 are inputted into a signal multiplexing circuit 401, and at the same time, the signal indicated which area or region is the operation region or area of the reproducing apparatus 101 is inputted into a signal processing circuit 402, a data conversion circuit 403, an encryption key producing circuit 404 and a data encrypting circuit 405.

The signal multiplexing circuit 401 conducts time-division multiplexing of the compressed AV signal, the RC signal and the CGM signal upon the video signal, which is expanded to be a base band. Since there are cases where the video signal of the expanded video signal is the same as that of the compressed AV signal and is different from that, multiplexing with the RC signal and the CGM signal, each of which regulates both the video signals is made.

An encrypting circuit 110 has the encryption methods having the key length of 40 bits or 56 bits, and 128 bits, and the signal processing circuit 402 supplies the signal by a unit of 24 bit to the data conversion circuit 403, in case where the signal from the controller circuit 116 indicates Japan, USA and Europe. The data conversion circuit 403 converts that signal of the unit of 24 bits into that having 40 bits or 56 bits, by adding all “0” or all “1” thereto.

In the case where the input signal from the controller circuit 116 indicates Japan, USA and Europe region, the encryption key producing circuit 404 and the data encrypting circuit 405 conduct the encryption with the key length of 40 bits or 56 bits, in accordance with the DHCP standard, and supply data encryption key signal of 40 bits or 56 bits to the data encrypting circuit 405, then the data encrypting circuit 405 supplies the re-encrypted AV signal to the transmission circuit 111.

In case where the input signal from the controller circuit 116 indicates Chinese region, the signal processing circuit 402 supplies the signal by a unit of 128 bits to the data conversion circuit 403, and the data conversion circuit 403 supplies the signal, after being converted into the unit of 128 bits by adding all “0” or all “1” to the signal of the unit of 128 bits or 24 bits, to the data encrypting circuit 405. The encryption key producing circuit 404 and the data encrypting circuit 405 conduct the encryption with the key length of 128 bits, in accordance with the Chinese encryption standard, and supply the data encryption key signal of 128 bits to the data encrypting circuit 405, and the data encrypting circuit 405 supplies the signal, which is re-encrypted and multiplexed, to the transmission circuit 111.

As was mentioned above, according to the present embodiment, within the apparatus for processing the AV signal therein, there is installed the device or mechanism enabling the copyright management system, which adopts the different encryption method depending on the regions or areas where the apparatus is used, the conventional data for regulating the region or area of reproduction is added onto the RC, and further there is added the device or mechanism for enabling to change or expand the region or area of reproduction depending upon the permission of the copyright owner, wherein the reproducing apparatus reproduces the AV signal, transmits it into the television method, and display it, while selecting the encryption method upon basis of the RC added to that AV information, or the changed or expanded information of the region or area of reproduction, thereby achieving the method and the apparatus for enabling the permitted equipment to reproduce the permitted AV information, irrespective of the region or area where they are sold.

With the above mentioned, it is possible for a user to select the region or area where the AV information can be reproduced, with a simple or one operation, or automatically, as well as, to reduce the costs necessary for the function of selecting the region or area where the reproduction can be made, for the manufacturer of the apparatus.

According to the present invention, it is possible to achieve an improvement in the usability of the information processing apparatus.

The present invention may be embodied in other specific forms without departing from the spirit or essential feature or characteristics thereof. The present embodiment(s) is/are therefore to be considered in all respects as illustrative and not restrictive, the scope of the invention being indicated by the appended claims rather than by the forgoing description and range of equivalency of the claims are therefore to be embraces therein.

What is claimed is:

1. An information processing apparatus, for processing information therein, comprising:
an input portion, through which a region where said information processing apparatus is used is inputted;
an encryption portion which encrypts the information; and
a control portion which controls said input portion and said encryption portion, wherein
said control portion controls said encryption portion depending upon the region where said information processing apparatus is used, which is inputted through said input portion.

2. The information processing apparatus, as described in the claim 1, further comprising a terminal for outputting an output from said encryption portion.

3. The information processing apparatus, as described in the claim 1, further comprising:
a reproduction portion which reproduces information from a recording medium detachable;
a memory portion which memorizes the information reproduced from said detachable recording medium; and
a connector portion which is connectable with Internet, wherein
said control portion connects to the Internet by means of said connector portion and also obtains information, which can cancel prohibition of reproduction, when reproduction from said reproduction portion is prohibited.

4. The information processing apparatus, as described in the claim 1, further comprising:
a reproduction portion which reproduces information from a recording medium detachable;
a memory portion which memorizes the information reproduced from said detachable recording medium; and
a connector portion which is connectable with Internet, wherein
said control portion connects to the Internet by means of said connector portion and also obtains information, which can cancel prohibition of memorization, when memorization into said reproduction portion is prohibited.

5. An information processing method, for processing information, comprising the following steps of:
inputting a region where the information is processed; and
encrypting the information depending upon the region where it is processed, wherein said encrypting is conducted depending upon the region which is inputted in said inputting.

6. The information processing method, as described in the claim 5, further comprising the following step:
outputting the information, which is conducted the encryption in the above step.

7. The information processing method, as described in the claim 5, further comprising the following step:
connecting to Internet and also obtaining information, which can cancel prohibition of reproduction, when reproduction of the information is prohibited.

8. The information processing method, as described in the claim 5, further comprising the following step:
connecting to Internet and also obtaining information, which can cancel prohibition of memorization, when memorization of the information is prohibited.

9. A method for managing copyright of video and audio information within equipment for processing thereof, having at least an encrypting circuit for coping with a copyright management system, which adopts an encrypting method differing from each other depending on a region where it is used, and an input portion, through which information of the region of use is inputted, wherein:
the encrypting method of said encrypting circuit is selected upon basis of said information of the region of use, which is obtained through said input portion for inputting the information of the region of use, and thereby processing the video and audio information.

10. The method for managing copyright of video and audio information, as described in the claim 9, wherein said encrypting circuit comprises an external terminal-use encrypting circuit for outputting at least the video and audio information to an outside, in form of digital information.

11. The method for managing copyright of video and audio information, as described in the claim 9, wherein said equipment further comprises:
a copyright management circuit, which processes a copy management signal of the video and audio information that is reproduced or received;
a recording/reproducing apparatus built within said equipment, which records the video and audio information that is reproduced or received; and
an Internet connector terminal, which is connectable to Internet, wherein
when a copy management signal prohibits copying, copyright control information of allowing to copy by a copyright manager is obtained from a copyright manger site through said Internet connector terminal, to be inputted into the copyright management circuit, so that the copyright management circuit controls the recording/reproducing apparatus upon basis of said copyright control information obtained.

12. An apparatus for processing video and audio information therein, comprising:
an encrypting circuit for coping with a copyright management system, which adopts an encrypting method differing from each other depending on a region where it is used; and
an input portion, through which information of the region of use is inputted, wherein
an encrypting method of said encrypting circuit is selected, upon basis of said information of the region of use, which is obtained from said input portion, through which information of the region of use is inputted, thereby processing the video and audio information.

13. The apparatus for processing video and audio information, as is described in the claim 12, wherein said encrypting circuit comprises an external terminal-use encrypting circuit for outputting at least the video and audio information to an outside, in form of digital information.

14. The apparatus for processing video and audio information, as is described in the claim 12, further comprising:
a copyright management circuit, which processes a copy management signal of the video and audio information that is reproduced or received;
a recording/reproducing apparatus built within said equipment, which records the video and audio information that is reproduced or received; and
an Internet connector terminal, which is connectable to Internet, wherein
when a copy management signal prohibits copying, copyright control information of allowing to copy by a copyright manager is obtained from a copyright manger site through said Internet connector terminal, to be inputted into the copyright management circuit, so that the copyright management circuit controls the recording/reproducing apparatus upon basis of said copyright control information obtained.
